(19) United States
(12) Patent Application Publication
(10) Pub. No.: US 2014/0078934 A1
(43) Pub. Date: Mar. 20, 2014

(54) DELAY FEEDBACK FOR COORDINATED MULTI-POINT TRANSMISSION

(71) Applicant: Nokia Corporation, Espoo (FI)

(72) Inventors: Klaus Hugl, Wien (AT); Cássio Ribeiro, Espoo (FI)

(73) Assignee: Nokia Corporation, Espoo (FI)

(21) Appl. No.: 14/115,791

(22) PCT Filed: May 2, 2012
(86) PCT No.: PCT/FI2012/050425

§ 371 Date: Nov. 5, 2013

Related U.S. Application Data
(60) Provisional application No. 61/484,379, filed on May 10, 2011.

(51) Int. Cl. H04L 12/761

(52) U.S. Cl. CPC H04L 45/16
USPC 370/254

(57) ABSTRACT

In accordance with the exemplary embodiments of the invention there is at least a method and an apparatus to perform operations including estimating, with a user equipment, one or more delays between receipts at the user equipment of transmissions from a plurality of transmission nodes (610); determining channel state information by compensating for the estimated one or more delays (620); and sending indications of the channel state information and the estimated one or more delays to at least one of the plurality of transmission nodes (630). Further, to perform receiving from a user equipment one or more indications of one or more delays between receipts at the user equipment of transmissions of a plurality of transmission nodes; determining, based on the received one or more delays, a transmission strategy for one or more subsequent transmissions from at least one of the plurality of transmission nodes to the information and the estimated one or more user equipment; and implementing the determined transmission strategy.

### TECHNICAL FIELD

This invention relates generally to wireless networks and, more specifically, relates to feedback from user equipment to base stations in wireless networks.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
CA carrier aggregation
CC component carrier
CDD cyclic delay diversity
CIF carrier indicator field
CoMP coordinated multi-point (transmission or reception)
CQI channel quality indicator
CRS cell-specific reference signals
CSI channel state information
CSI-RS channel state information reference signals
DCI downlink control information
DL downlink (from the network to a UE)
DM-RS demodulation reference signal
eNB, eNodeB EUTRAN Node B (evolved Node B/base station)
EPC evolved packet core
EUTRAN evolved universal terrestrial access network
FDPS frequency domain packet scheduling
HARQ hybrid automatic repeat request
JT joint transmission
MAC medium access control (layer 2, L2)
MCS modulation and coding scheme
MIMO multiple input multiple output
MM/MME mobility management/mobility management entity
OFDMA orthogonal frequency division multiple access
PDCCH physical downlink control channel
PDCP packet data convergence protocol
PDSCH physical downlink shared channel
PHY physical (layer 1, L1)
PMI precoding matrix indicator
RLC radio link control
RI rank indicator
RRC radio resource control
RRH remote radio head
RS reference symbol
RSRP reference symbol received power
RSRP reference symbol received quality
Rx or RX reception or receiver
SC-FDMA single carrier-frequency division multiple access
SGW, SG-W serving gateway
SRS sounding reference signals
Tx or TX transmission or transmitter
UE user equipment (e.g. mobile terminal)
UL uplink (from a UE to the network
UPE user plane entity

One modern communication system is known as evolved UTRAN (E-UTRAN, also referred to as UTRAN-LTE or as E-UTRA). FIG. 1 reproduces FIG. 4-1 of 3GPP TS 36.300 and shows an overall architecture of the EUTRAN system. The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of an S1 MME interface and to a S-GW by means of a S1 interface (MME/S-GW). The S1 interface supports a many-to-many relationship between MMEs/S-GWs/UPEs and eNBs. In this system, the DL access technique is OFDMA, and the UL access technique is SC-FDMA. The EUTRAN system shown in FIG. 1 is one possible system in which the exemplary embodiments of the instant invention might be used.

### SUMMARY

In an exemplary aspect of the invention, there is a method comprising estimating, with a user equipment, one or more delays between receipt at the user equipment of transmissions from a plurality of transmission nodes; determining channel state information by compensating for the estimated one or more delays; and sending indications of the channel state information and the estimated one or more delays to at least one of the plurality of transmission nodes.

In an exemplary aspect of the invention, there is an apparatus comprising: at least one processor; and at least one memory including computer program code, where the at least one memory and the computer program code are configured, with the at least one processor, to cause the apparatus to at least: estimate one or more delays between transmissions received at the apparatus from a plurality of transmission nodes; determine channel state information by compensating for the estimated one or more delays; and send indications of the channel state information and the estimated one or more delays to at least one of the plurality of transmission nodes.

In an exemplary aspect of the invention, there is an apparatus comprising: means for estimating one or more delays between transmissions received at the apparatus from a plurality of transmission nodes; means for determining channel state information by compensating for the estimated one or more delays; and means for sending indications of the channel state information and the estimated one or more delays to at least one of the plurality of transmission nodes.

The apparatus according to the paragraph above, wherein the means for estimating and determining comprises at least one memory including computer program code, the computer program code executable by at least one processor, and wherein the means for sending comprises an interface to a wireless network.

In an exemplary aspect of the invention, there is a method comprising: receiving from a user equipment one or more indications of one or more delays between receipt at the user equipment of transmissions of a plurality of transmission nodes; determining, based on the received one or more delays, a transmission strategy for one or more subsequent transmissions from at least one of the plurality of transmission nodes to the user equipment; and implementing the determined transmission strategy.

In still another exemplary aspect of the invention, there is an apparatus comprising: at least one processor; and at least one memory including computer program code, where the at least one memory and the computer program code are configured, with the at least one processor, to cause the apparatus to at least: receive from a user equipment one or more indications of one or more delays between receipt at the user equipment of transmissions of a plurality of transmission nodes; determine, based on the received one or more delays, a transmission strategy for one or more subsequent transmissions from at least one of the plurality of transmission nodes to the user equipment; and implement the determined transmission strategy.

In yet another exemplary aspect of the invention, there is an apparatus comprising: means for receiving from a user equipment one or more indications of one or more delays between receipt at the user equipment of transmissions of a plurality of transmission nodes; means for determining, based on the received one or more delays, a transmission strategy for one or more subsequent transmissions from at least one of the plurality of transmission nodes to the user equipment; and means for implementing the determined transmission strategy.

The apparatus according to the paragraph above wherein the means for determining and implementing comprises at least one memory including computer program code, the computer program code executable by at least one processor, and wherein the means for receiving comprises an interface to a wireless network.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 reproduces FIG. 4-1 of 3GPP TS 36.300 and shows the overall architecture of the EUTRAN system (Rel-8);

FIG. 2 shows a simplified block diagram of various electronic devices that are suitable for use in practicing the exemplary embodiments of this invention;

FIG. 3 is an example of a macro cell having multiple transmission nodes within the macro cell;

FIG. 4 is a graph of power on the effective channel seen by a UE receiver for a joint transmission from two transmission nodes with different values for the delay τ_{JT};

FIG. 5 is an exemplary signaling diagram/flow chart of operations performed in a macro cell for delay feedback for joint transmission CoMP and single cell joint transmission with distributed antenna arrays; and

FIG. 6 and FIG. 7 are each simplified block diagrams which illustrate a method in accordance with an exemplary embodiment of the invention.

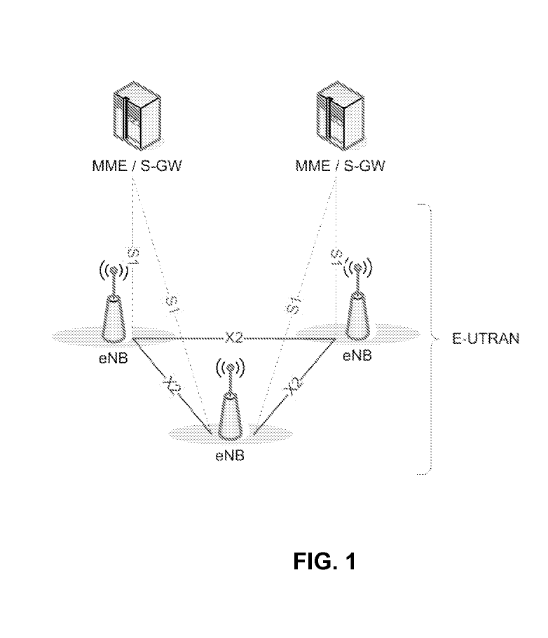

### DETAILED DESCRIPTION

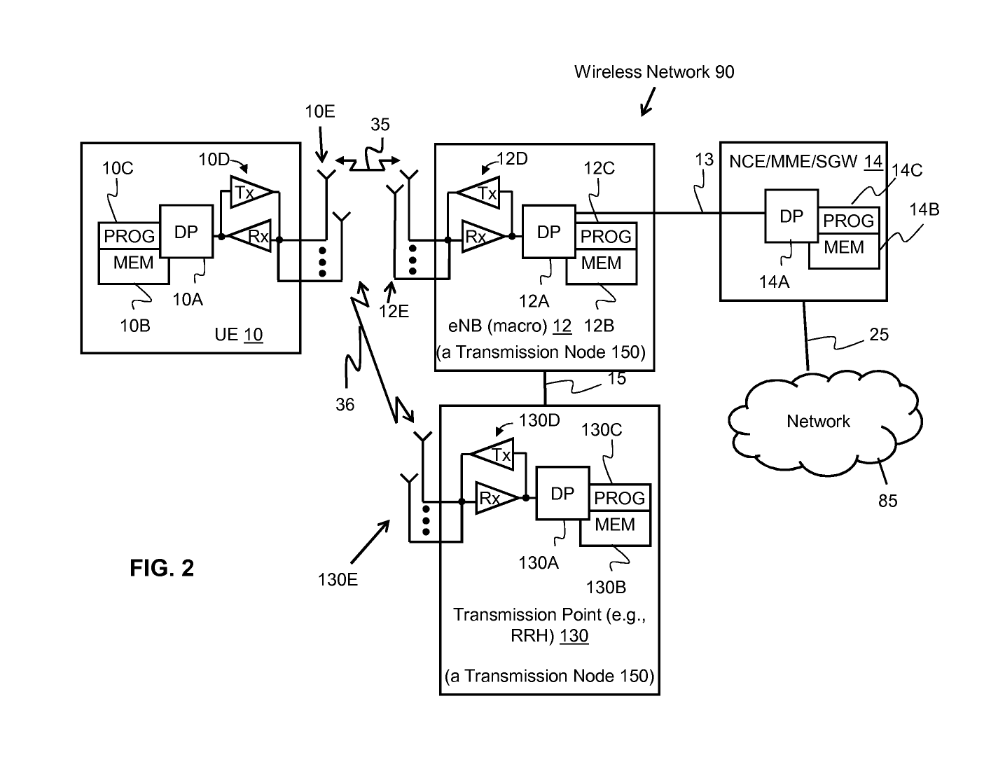

Before describing in further detail the exemplary embodiments of this invention, reference is made to FIG. 2 for illustrating a simplified block diagram of various apparatus that are suitable for use in practicing the exemplary embodiments of this invention. In FIG. 2, a wireless network 90 includes an eNB 12, an NCE/MME/SGW 14, and a transmission point such as RRH 130. The wireless network 90 is adapted for communication over a wireless link 35 with an apparatus, such as a mobile communication device which may be referred to as a UE 10, via a network access node, such as a Node B (base station), and more specifically an eNB 12. The network 90 may include a network control element (NCE) 14 that may include MME/SGW functionality, and which provides connectivity with a further network, such as a telephone network and/or a data communications network 85 (e.g., the internet) through link 25. The NCE 14 includes a controller, such as at least one data processor (DP) 14A, and at least one non-transitory computer-readable memory medium embodied as a memory (MEM) 14B that stores a program of computer instructions (PROG) 10C.

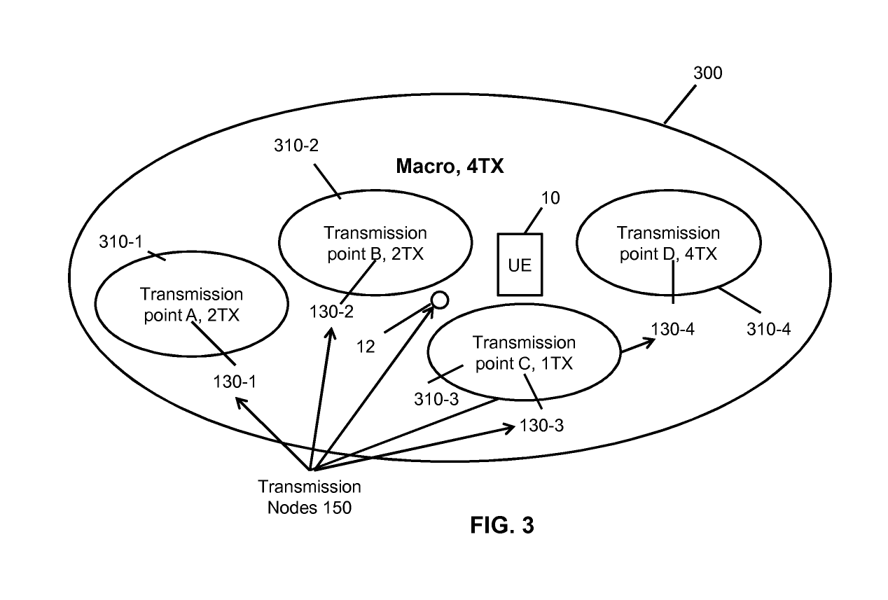

The UE 10 includes a controller, such as at least one data processor (DP) 10A, at least one non-transitory computer-readable memory medium embodied as a memory (MEM) 10B that stores a program of computer instructions (PROG) 10C, and at least one suitable radio frequency (RF) transceiver 10D for bidirectional wireless communications with the eNB 12 via one or more antennas 10E. The eNB 12 also includes a controller, such as at least data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas 12E (typically several when multiple input, multiple output (MIMO) operation is in use). The eNB 12 is coupled via a data and control path 13 to the NCE 14. The path 13 may be implemented as an S1 interface. The eNB 12 may also be coupled to another transmission point via data and control path 15, which may be implemented as an X2 interface in case of another logical base station or can be a direct eNodeB internal interface, e.g., optical fiber connection, to connect some transmission point such as radio remote head (RRH) to the eNB 12. Typically, the eNB 12 covers a single macro cell (shown in FIG. 3) via the one or more antennas 12E.

In this example, the transmission point 130 includes a controller, such as at least data processor (DP) 130A, at least one computer-readable memory medium embodied as a memory (MEM) 130B that stores a program of computer instructions (PROG) 130C, and at least one suitable RF transceiver 130D for communication with the UE 10 via one or more antennas 130E (as stated above, typically several when MIMO operation is in use). The transmission point 130 communicates with the UE 10 via a link 36. The transmission point 130 may communicate, depending on implementation, with the eNB 12 using a data and control path 15. The transmission point 130 can be another eNodeB or can be logically be part of eNB 12 as, e.g., enabled by a Radio Remote Head (RRH) and creates some local hotspot coverage 310 inside the macro cell coverage area (as shown in FIG. 3). For single-cell operation, all of the transmission points 130 (see also FIG. 3) are typically under complete control of a single eNB 12 (although dispersed control is also possible). Thus, there is generally centrally some unit where several transmission points (e.g., RRHs) 130 are connected as such. The idea is that the transmission points 130 and the macro eNB 12 are centrally controlled together. The control is typically at the location of the macro eNB 12 (and this is assumed for simplicity throughout the instant application), but could also be at a location that is connected to the eNB 12 and the transmission point(s) 130.

It is noted that in the exemplary embodiments of the instant invention, the eNB 12 or the transmission points 130 may apply the techniques presented herein. That is, a UE 10 may communicate with multiple transmission points 130 or with the eNB 12 and one or more transmission points 130. For this reason, the eNB 12 and the transmission points 130 are called transmission nodes 150 herein (with two transmission nodes 150-1 and 150-2 shown in FIG. 2).

At least one of the PROGs 10C, 12C, and 130C is assumed to include program instructions that, when executed by the associated DP, enable the corresponding apparatus to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, and/or by the DP 130A of the transmission point 130, or by hardware (e.g., an integrated circuit configured to perform one or more of the operations described herein), or by a combination of software and hardware (and firmware).

In general, the various embodiments of the UE 10 can include, but are not limited to, cellular telephones, tablets having wireless capability, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B, 12B, and 130B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A, 12A, and 130A may be of any type suitable to the local technical environment, and may include one or more of general purpose computers, special purpose computers, microprocessors, digital signal processors (DSPs) and processors based on multi-core processor architectures, as non-limiting examples.

One example of a heterogeneous CoMP deployment scenario or MIMO deployment scenario with geometrically distributed transmission nodes of interest in this case is depicted in FIG. 3. Within the coverage area 300 of one macro eNB 12 with, e.g., 4 (four) TX antennas 12E, there are altogether four hotspots 310-1 through 310-4 created by four transmission points 130-1 through 130-4, each having some (1, 2, and 4 are shown although 8 or more is also possible) transmit antennas 130E. There are therefore five transmission nodes 150 in FIG. 3: four transmission points 130-1 through 130-4 and the macro eNB 12. The UE 10 may be able to communicate only with the eNB 12 or with one or more of the transmission points 130 (e.g., with transmission points 130-2 through 130-4 but not with transmission point 130-1).

It should be noted that the problems and solutions described herein are valid for traditional macro-cell COMP operation as well as operations having distributed antennas within a cell (e.g., enabled by RRHs).

The main problem with joint transmission from several physically distributed transmission points is that the transmissions may not be received at the UE exactly at the same time. This can be attributed to two effects:
1) The transmission from the different transmission nodes 150 may not be occurring exactly at the same time: this means that there may be a small delay between the transmissions from the transmission nodes. This delay is denoted as τ_{TX}.
2) Given by the fact that the distances from the different transmission nodes to the UE may not the same, the path-length difference is therefore creating a delay denoted here as Tₚₐₜₕ. This path-delay difference is especially of importance when considering heterogeneous deployments, where the different transmission nodes might have quite different transmission powers. Therefore, the transmission nodes might be seen with similar signal strength values at the terminal receiver, even though the UE may be much closer to the low-TX power node (e.g., micro or low-power RRH) compared to the high-TX power node (e.g., macro or high-power RRH).

The total delay at the UE receiver between two transmissions from the separate nodes is therefore given by τ_{JT}=τ_{TX+τ}ₚₐₜₕ. This delay, for the example considering two transmission nodes, results in a phase difference of the received signals of these two transmission nodes given by Δφ=exp(j2πfτ_{JT}). The problem that arises now is that within the operational bandwidth between the transmission node(s) and a specific UE of, for example up to 20 MHz (mega-Hertz) for standard LTE and even higher bandwidths for LTE using carrier aggregation, this delay creates a frequency-dependent phase variation Δφ(f)=exp(j2π·f·τ_{JT}), which depends now on the delay.

In order to illustrate how this frequency-dependent delay influences reception at the UE, consider a system where the UE is receiving signals of equal amplitude from two transmission nodes. The total signal received at the UE is given by

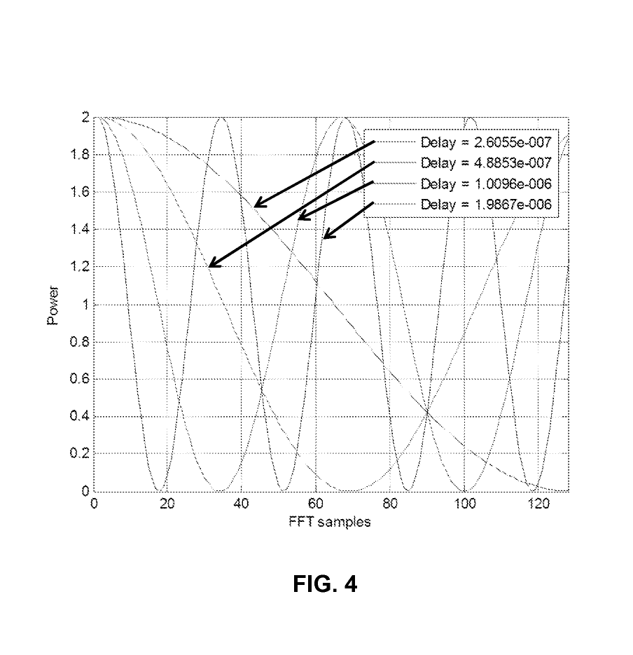

y(f)=[H₁(f)+H₂(f)]x(f),

where H₁(f) and H₂(f) are the channels transmitted from two different Tx points, and x(f) is the transmitted data. Assume for simplicity each transmission node has one TX antenna and H₁(f)=1, i.e., this channel corresponds to the reference transmission node to which the UE is synchronized, and H₂(f)=exp(j2π·f·τ_{JT}), i.e., this channel has same power as H₁(f), but with delay that translates into a frequency dependent phase variation. The power of the combined channel H_{combined}(f)=H₁(f)+H₂(f)=1+exp(j2π·f·τ_{JT}) at the receiver is shown in FIG. 4 for different values of τ_{JT}. It is clear that for any delay value, there are frequencies where the two signals combine destructively instead of constructively as intended. Moreover, for higher delay values the difference in frequency between the peaks of maximum and minimum power becomes smaller as well. For example, for τ_{JT}≈1 μs (about one microsecond), the channel oscillates between maximum and minimum values within a difference slightly larger than two physical resource blocks (PRBs) or 24 subcarriers of the LTE system. For a combined delay of τ_{JT}≈2 μs, the full variation (phase change of π) is realized within a single PRB—meaning, that even frequency selective phase adjustment feedback on a PRB per PRB basis between the two transmission nodes would not be sufficient any longer to guarantee some kind of constructive superposition of the transmission signals of the two TX nodes at the UE.

It should be noted that the variations above are for delays comfortably within the cyclic prefix of 4.7 μs, but because of the assumption that the two signals are supposed to have similar power at the receiver, the supported data rate would be much lower and especially higher code rates would not be applicable due to the strong signal strength fluctuations within the scheduled bandwidth.

The problem then is crystallized as follows. For joint transmission, there is a need to give feedback to the transmission nodes 150 on how the phase between the different transmission nodes should be adapted in order to get coherent, wide(r)-band over-the-air combining of the transmissions of the different transmission nodes. The delay now creates the problem that there would be a need to adapt the relative phase between transmission nodes in a frequency selective manner—namely, the eNodeB 12 is (or the transmission nodes 150 are) not aware of how large the delay as such is and if the delay is within limits so that joint transmission as such would still make sense.

An exemplary embodiment of the instant invention includes the delay information in the PMI feedback information, which gives the transmission nodes 150 more information and therefore provides additional ability for the transmission nodes 150 to decide and update their transmission strategy.

In contrast to the phase feedback envisioned in R1-111276 (3GPP TSG-RAN WG1 Meeting #65, Barcelona, Spain, May 9-13, 2011, Source: Nokia Siemens Networks, Nokia, title: “Further DL CoMP phase1 simulation results,” (as forms part of this application) and several other contributions, which use amplitude and phase as a measure (through explicit and implicit feedback), it is suggested herein to include a measure of the delay in the feedback. This reduces the need for frequency-selective relative phase feedback between the different transmission nodes and/or provides the eNodeB more information on how to adapt the transmission.

Compared to phase feedback, the following exemplary differences are described:
1) The delay is a single (non-frequency selective) measure that gives the transmission nodes 150 information on how frequency selective the joint transmission from several transmission nodes would be. The phase information is limited to the frequency granularity of the feedback, and also is limited as such by the PRB size of 12 subcarriers defined in LTE. Both of these limitations do not exist for the delay feedback.
2) By knowing the delay information, the transmission node 150 is aware of the quality of the gathered feedback information over the frequency domain and might use this to decide on how to transmit, such as in the following exemplary techniques:
a) Adapt the frequency selective phase between different transmission nodes to balance/counteract the frequency selective phase offset created by the delay τ_{JT} (i.e., for a selected one of the transmission nodes 150 having the delay, multiplying the signal to be transmitted by that selected transmission node in the frequency domain by exp(−j2π·f·τ_{JT})). A person skilled in the art may recognize that any arbitrary frequency selective phase could be additionally added to all the transmission points in the same way so that the resulting relative phase offset would be again given by exp(−j2π·f·τ_{JT}) between the TX points, e.g., to enable only positive phase offsets for all the involved transmission points.
b) Adapt the transmission in the different transmission nodes: the transmission nodes 150 might create some cyclic shift/delay between the different transmission nodes for the transmission dedicated to the UE (DM-RS and PDSCH) to balance/counteract the frequency selective phase offset.
c) Refrain from joint transmission due to (too) large frequency selectivity.

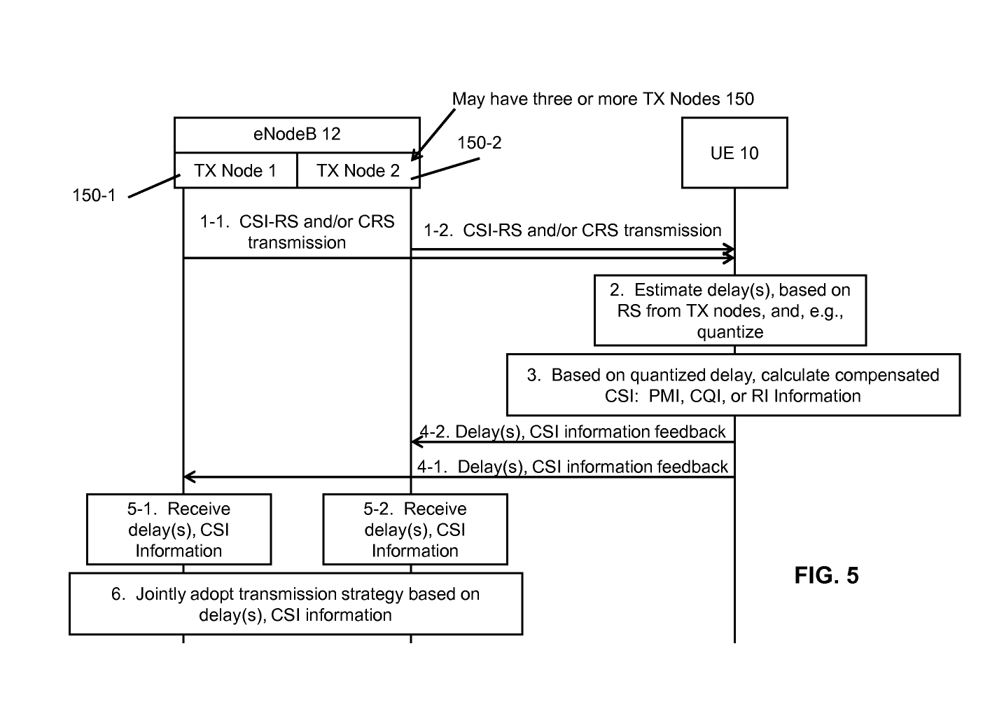

FIG. 5 is an exemplary signaling diagram/flow chart of operations performed in a macro cell for delay feedback for joint transmission CoMP and single cell joint transmission with distributed antenna arrays. The figure shows two transmission nodes 150-1, 150-2 and the eNodeB 12 acting as the controlling entity for the two transmission nodes 150. As described above, one or more of the transmission nodes 150 may be an eNodeB. This example has a centrally located decision maker of the eNodeB 12 (as discussed below, the decision making may also be distributed). Additionally, although only two transmission nodes 150 are shown, three or more transmission nodes may be used. A delay could be calculated for each transmission node other than a reference one of the transmission nodes. Alternatively, in some cases, it could be sufficient to use a single delay value for all other TX nodes, which would be computed based on some optimization criterion to provide the best performance.

As shown in FIG. 5, in steps 1-1 and 1-2, each TX node 150-1, 150-2 transmits CSI-RS and/or CRS transmission to the UE 10. The UE 10 in step 2 then estimates delay(s) between the received signals from transmission nodes and quantizes (in an exemplary embodiment) the delay. An assumption here is that the measurements are based on, e.g., orthogonal CSI-RS (or CRS) transmissions configured for the different Tx nodes 150. In this case, it is straightforward to estimate the channels independently and determine the relative delays. In an example, the UE 10 calculates an equivalent delay, which would result in the best fit of coherent combining of the received signals from the transmission nodes over the full operational bandwidth. This estimation and quantization is based on the RS (e.g., CSI-RS or CRS) from the different TX nodes 150.

It is noted that the delay is determined relative to a reference transmission node 150. That is, one of the transmission nodes 150 is selected as the reference transmission node 150, and the delay is calculated relative to that transmission node 150. For instance, if a transmission by the other transmission node 150 is received at the UE prior to the transmission by the reference transmission node 150, then the delay technically is negative. However, the UE 10 and eNB 12 will both be able to determine which transmission node 150 is the reference transmission node. For instance, the eNB 12 could signal which node is the reference transmission node to the UE 10, or the UE 10 could signal which node is the reference transmission node to the eNB 12 as part of the feedback signaling. The reference transmission node might as an example be chosen as the one from which the signals are arriving first at the UE.

In step 3, based on the quantized delay estimate(s), the UE 10 calculates “compensated” CSI information, which includes, as examples, one or more of the PMI, CQI information, and RI information. How to compute compensated CQI, PMI, or RI based on delay is described below. By using the delay, the UE 10 can convert (as an example) a channel that is observed as the curve for the delay of 1.9867 e−006 (i.e., 1.9867×10⁻⁶) in FIG. 4 to something like the curve for the delay of 2.6055 e−007 (i.e., 2.6055×10⁻⁷), or preferably even less power variation over the scheduled transmission bandwidth, depending on the quantization levels of the delay. That is, referring to CQI as another example, in the “compensated for” CQI, the signal strength variations shown in FIG. 4 might not exist or will be lessened. If one calculates the CQI without considering the delay compensation, the channel quality would be calculated based on the varying signal quality as shown in FIG. 4.

In steps 4-1 and 4-2, the UE 10 transmits indications of the delay(s) and indication(s) of the compensated CSI, including one or more of PMI, CQI, and RI feedback. In steps 4-1 and 4-2, typically the same information is transmitted to both transmission nodes (e.g., in case of single-cell MIMO with distributed antennas and one way to implement joint transmission CoMP)—but could be also only PMI, CQI, delay separately signaled (for another possible COMP operation). The TX nodes 150-1, 150-2 receive the delay information and the CSI information in steps 5-1 and 5-2. In step 6, all the involved transmission nodes 150 then jointly adopt a transmission strategy based on the received CSI. It should be noted that generally control of multiple transmission points is easier implemented using a centralized decision making (i.e., decisions performed at one centralized point such as eNodeB 12)—but distributed decision making is possible as well. For centralized decision making, the eNB and RRHs are controlled centrally and share some processing units, for example. Additionally, for the example of three transmission nodes 150, there might be two different delays to compensate for, e.g., τ₂ for TX node 2 relative to TX node 1 and τ₃ for TX node 3 relative to TX node 1. Moreover, the delay is specific only for the scheduled transmission bandwidth for the UE of interest (e.g., DM-RS or PDSCH). A different delay or no delay is then applied in another part of the TX bandwidth (e.g., where this UE is not scheduled).

Further indication by higher layers is needed to trigger the UE to utilize the quantized delay compensated CQI/PMI/RI reports instead of regular reports without any compensation of the delay being assumed. Such indication can be done by signaling or as part of the configuration of a CoMP or MIMO transmission mode. As described above, different configurations might be envisioned, considering a single relative delay for each group of transmission nodes 150 or a separate relative delay for each individual transmission node. In this case, a UE configured to operate in at least one of the possible CoMP or MIMO transmission modes would be required to feedback the quantized delay and report CQI/PMI/RI accordingly assuming compensation of the delay by the transmission nodes 150. In case signaling is used to enable CQI/PMI/RI reports assuming delay compensation, this signaling can be combined with a trigger for the UE to feedback delay information or can be indicated separately.

CSI information calculation (step 3 in FIG. 5) and signaling (step 4 in FIG. 5) may be performed as follows. As described above, the intention in the UE 10 is to calculate the relative equivalent delay between the different transmission nodes—and take the quantized delay to be fed back into account (assuming the eNodeB 12 will perfectly balance the reported delay) when calculating the (e.g., constant, or very coarse in frequency domain) amplitude and phase information between the transmission nodes 130. In addition, for each transmission node 150 also the PMI for each of the transmission nodes 150 needs to be calculated—as laid out in, e.g., R1-111276, as well as the transmission rank indicated by the RI as well as the channel quality given by the CQI, taking the quantized delay into account.

In case the equivalent delay at the receiver would be too large to compensate for, e.g. in case the transmission would cause severe inter-symbol interference—meaning the delay would be in the order of the cyclic prefix, or if the delay is larger than the maximum available quantization level for the delay, the UE would still calculate the delay but would recognize that sufficient compensation at the transmitter point side will be not possible and therefore the delay compensated joint transmission from several physically separated (i.e., not at the same position and separated typically by at least several meters) transmission nodes might therefore not make sense. In this case, the UE would not assume the delay compensation in the PMI/RI/CQI calculation but only calculate this channel state information assuming either non-compensated multi-point transmission or even single transmission node transmission instead. The equivalent delay value defining this threshold between delay compensated PMI/RI/CQI and non-delay compensated PMI/RI/CQI reporting could be either specified or given by higher layer signaling from the network nodes to the UE.

Perfect compensation of the delay is probably not possible and optimal compensation accuracy needs to take into account the overall feedback overhead. However, as shown in FIG. 4, a small delay may be tolerable as a small delay does not cause significant degradation within one PRB or small scheduled bandwidth for a UE. Anyway, given a certain accuracy of the delay reporting, the UE can take the residual equivalent delay into account when calculating the CQI/PMI/RI feedback.

For example, assume the UE 10 feeds back the quantized delay τ_{Q}, and that the granularity of quantization is Δ, i.e., |τ_{Q}−τ_{JT}|≦Δ. The eNB 12 (or the transmission nodes 150 acting together) can then apply the following compensation on the resources scheduled to the UE: Δφ=exp(−j2πfτ_{Q}), but applied only on the resources scheduled to that UE.

Due to the quantization of delay, there will be a residual delay up to Δ. Assuming compensation for τ_{Q} by a transmission node 150 (e.g., under control of the eNodeB 12), the equivalent channel of the second transmission node would become the following:

H_{2,compensated d}(f)=exp(−j2πfτ_{Q})H₂(f).

Hence, the received signal for data transmission from the cooperating transmission nodes 150 will be given by

y_{compensated}(f)=[H₁(f)+H_{2,compensated}(f)]x(f),

and the UE 10 can compute the CQI/PMI/RI feedback assuming this cooperative, delay compensated signal model (i.e., [H₁(f)+H_{2,compensated}(f)]).

It is helpful at this point to describe the relation of the delay compensation to cyclic delay diversity (CDD). CDD is described in, e.g., Stefania Sesia, et al., “LTE—The UMTS Long Term Evolution”, pages 263-266 (2009). Briefly, in CDD, a cyclic shift/delay is added to one or more antenna branches but not added to other antenna branch(es) for co-located antennas. In the instant technique, the operation can be seen as similar to that required to implement small-delay CDD, but with some key differences:
1) The different antennas in the instant techniques are geographically separated, and there is no cyclic shift/delay between antenna branches in each transmission node having co-located antennas. Instead, only a cyclic delay between the “groups” of antenna branches is applied in the techniques herein, where each group would represent co-located antennas geographically separated from another group.
2) The delay in the instant techniques is used to revert the delay between the branches instead of (in CDD) inserting a delay to create diversity.
3) The delay in the instant technique could be different for different parts of the frequency band as a different cyclic delay may be needed for a different scheduled UE, whereas in case of CDD a single cyclic delay value is used by the transmission node for its whole operational bandwidth.

The frequency of reports may be as follows. The relative delay between the different received signals from different TX points will not change that quickly (compared to the CQI/PMI), as the UE would need to travel several meters before a difference in the reported delay appears. Therefore, the delay reporting might not happen with the same reporting frequency as the PMI & CQI. Otherwise, the implementation would be similar to the implementation for reporting as in normal COMP/single-cell MIMO transmission.

In an exemplary embodiment of the invention, there is a method which includes estimating one or more delays between receipt at the user equipment of transmissions from a plurality of transmission nodes to the user equipment; determining channel state information by compensating for the estimated one or more delays; and transmitting indications of the channel state information and the estimated one or more delays to at least one of the plurality of transmission nodes.

The method of the previous paragraph, where each delay is relative to one of the plurality of transmission points and a reference one of the plurality of transmission points.

The method of the previous sentence, wherein transmitting further comprises transmitting a plurality of indications of the plurality of delays.

The method according to paragraphs above, wherein the one or more delays are equivalent delays that would result in a best fit of coherent combining of received signals from the plurality of transmission nodes over a full operational bandwidth.

The method according to paragraphs above, wherein the one or more delays are delays computed as providing a best performance relative to other calculated delays according to a pre-defined metric.

The method according to paragraphs above, where the one or more delays is a single delay.

The method according to paragraphs above, wherein determining channel state information further comprises: for each of the one or more delays, applying a corresponding delay for a selected one of the plurality of transmission nodes to a channel function for the selected transmission node to create a compensated channel function; and determining the channel state information using the compensated channel functions.

The method according to paragraphs above, wherein identical information is transmitted in each of the transmissions.

The method according to paragraphs above, wherein estimating further comprises estimating the one or more delays using one or more of channel state information reference signals or cell-specific reference signals transmitted in each of the transmissions.

The method according to paragraphs above, wherein the method further comprises quantizing the estimated one or more delays; and determining further comprises determining, the channel state information using the quantized estimated one or more delays.

The method according to paragraphs above, wherein determining channel state information further comprises determining the channel state information as one or more of a precoding matrix indicator, a channel quality indicator, or a rank indicator at least by compensating for the estimated one or more delays.

An apparatus comprising one or more processors; and one or more memories including computer program code, the one or more memories and the computer program code configured to, with the one or more processors, cause the apparatus to perform any one of the methods of the previous paragraphs. More specifically, the one or more memories and the computer program code configured to, with the one or more processors, cause the apparatus to perform: estimating one or more delays between receipt at the user equipment of transmissions from a plurality of transmission nodes to the user equipment; determining channel state information by compensating for the estimated one or more delays; and transmitting indications of the channel state information and the estimated one or more delays to at least one of the plurality of transmission nodes.

A computer program product comprising a computer-readable medium bearing computer program code embodied therein for use with a computer, the computer program code comprising code for performing any of the methods of the previous paragraphs. Specifically, the computer program code comprises: code for estimating one or more delays between receipt at the user equipment of transmissions from a plurality of transmission nodes to the user equipment; code for determining channel state information by compensating for the estimated one or more delays; and code for transmitting indications of the channel state information and the estimated one or more delays to at least one of the plurality of transmission nodes.

An apparatus comprising means for performing any one of the methods of the previous paragraphs. Specifically, the apparatus could comprise means for estimating one or more delays between receipt at the user equipment of transmissions from a plurality of transmission nodes to the user equipment; means for determining channel state information by compensating for the estimated one or more delays; and means for transmitting indications of the channel state information and the estimated one or more delays to at least one of the plurality of transmission nodes.

In another exemplary embodiment, there is a method including receiving from a user equipment one or more indications of one or more delays between receipt at the user equipment of transmissions from a plurality of transmission nodes to the user equipment; determining, based on the received one or more delays, a transmission strategy for one or more subsequent transmissions from the plurality of transmission nodes to the user equipment; and implementing the determined transmission strategy.

The method according to the paragraph above, wherein identical information is transmitted for the user equipment depending on the selected transmission strategy in each of the subsequent one or more transmissions.

The method according to paragraphs above, wherein the determining further comprises determining the transmission strategy that the one or more subsequent transmissions from the plurality of transmission nodes to the user equipment should not be performed and instead the one or more subsequent transmissions should be performed from a selected one of the plurality of transmission nodes to the user equipment; and implementing further comprises causing the selected transmission node to transmit the one or more subsequent transmissions to the user equipment.

The method according to paragraphs above, wherein the determining further comprises determining the transmission strategy that one or more frequency selective phases should be adapted between the plurality of transmission nodes, wherein the one or more frequency selective phases are determined using the one or more delays; and implementing further comprises causing signals to be transmitted as part of the one or more subsequent transmissions for selected ones of the plurality of transmission nodes to be modified prior to transmission by corresponding ones of the one or more frequency selective phases.

The method according to paragraphs above, wherein the plurality of transmission nodes comprises two or more transmission nodes; the one or more delays is a plurality of delays; the one or more frequency selective phases is a plurality of frequency selective phases, wherein each of the plurality of frequency selective phases is determined using a corresponding one of the plurality of delays; causing signals to be transmitted further comprises causing signals to be transmitted as part of the one or more subsequent transmissions from selected ones of the two or more transmission nodes to be modified prior to transmission by corresponding ones of the one or more frequency selective phases.

The method according to paragraphs above, wherein the plurality of transmission nodes comprises two or more transmission nodes; the one or more delays is a single delay; the one or more frequency selective phases is single frequency selective phase, wherein the single frequency selective phase is determined using the single delay; causing signals to be transmitted further comprises causing signals to be transmitted as part of the one or more subsequent transmissions from selected ones of the two or more transmission nodes to be modified prior to transmission by the single frequency selective phase.

The method according to paragraphs above, wherein modification by a frequency selective phase comprises multiplying a corresponding signal in the frequency domain by exp(−j2π·f·τ), where f is a frequency and τ is a corresponding delay.

The method according to paragraphs above, wherein determining further comprises determining the transmission strategy that cyclic shifts/delays should be adapted between the plurality of transmission nodes, wherein one or more cyclic shifts/delays are determined using the received one or more delays; and implementing further comprises causing signals to be transmitted as part of the one or more subsequent transmissions for selected ones of the plurality of transmission nodes to be cyclically shifted/delayed prior to transmission by a corresponding one of the one or more cyclic shifts/delays.

The method according to paragraphs above, wherein the plurality of transmission nodes comprises two or more transmission nodes; the one or more delays is a plurality of delays; causing signals to be transmitted further comprises causing signals to be transmitted as part of the one or more subsequent transmissions for selected ones of the two or more transmission nodes to be cyclically shifted/delayed prior to transmission by corresponding ones of the cyclic shifts/delays.

The method according to paragraphs above, wherein the plurality of transmission nodes comprises two or more transmission nodes; the one or more delays is a single delay; causing signals to be transmitted further comprises causing signals to be transmitted as part of the one or more subsequent transmissions from selected ones of the two or more transmission nodes to be cyclically shifted/delayed prior to transmission by the single cyclic shift/delay.

The method according to paragraphs above, wherein one of the plurality of transmission nodes is selected as a reference transmission node and wherein the one or more delays are in reference to the transmission from the reference transmission node to the user equipment.

The method according to paragraphs above, wherein each of the one or more delays is one of a plurality of predetermined quantized values.

An apparatus comprising one or more processors; and one or more memories including computer program code, the one or more memories and the computer program code configured to, with the one or more processors, cause the apparatus to perform any one of the methods of the previous paragraphs. Specifically, the one or more memories and the computer program code configured to, with the one or more processors, cause the apparatus to perform: receiving from a user equipment one or more indications of one or more delays between receipt at the user equipment of transmissions from a plurality of transmission nodes to the user equipment; determining, based on the received one or more delays, a transmission strategy for one or more subsequent transmissions from the plurality of transmission nodes to the user equipment; and implementing the determined transmission strategy.

A computer program product comprising a computer-readable medium bearing computer program code embodied therein for use with a computer, the computer program code comprising code for performing any of the methods of the previous paragraphs. Specifically, the computer program code comprising: code for receiving from a user equipment one or more indications of one or more delays between receipt at the user equipment of transmissions from a plurality of transmission nodes to the user equipment; code for determining, based on the received one or more delays, a transmission strategy for one or more subsequent transmissions from the plurality of transmission nodes to the user equipment; and code for implementing the determined transmission strategy.

An apparatus comprising means for performing any one of the methods of the previous paragraphs. Specifically, the apparatus could comprise means for receiving from a user equipment one or more indications of one or more delays between receipt at the user equipment of transmissions from a plurality of transmission nodes to the user equipment; means for determining, based on the received one or more delays, a transmission strategy for one or more subsequent transmissions from the plurality of transmission nodes to the user equipment; and means for implementing the determined transmission strategy.

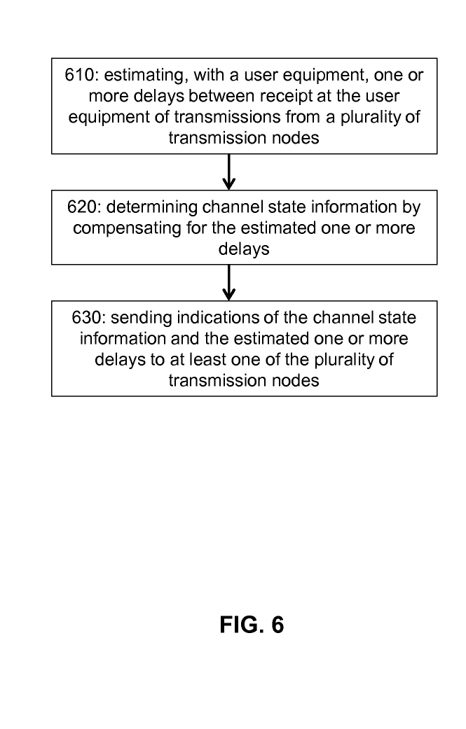

FIG. 6 is a block diagram illustrating a method in accordance with the exemplary embodiments of the invention. In still another exemplary embodiment, as illustrated in FIG. 6, at block 610 there is estimating, with a user equipment, one or more delays between receipt at the user equipment of transmissions from a plurality of transmission nodes. At block 620 there is determining channel state information by compensating for the estimated one or more delays, and at block 630 there is sending indications of the channel state information and the estimated one or more delays to at least one of the plurality of transmission nodes.

The method as described in the paragraph above, where each delay of the one or more delays is estimated relative to a transmission received from a reference one of the plurality of transmission nodes.

The method according to paragraphs above, wherein the sending further comprises sending a plurality of indications of the one or more delays.

The method according to paragraphs above, wherein the one or more delays are equivalent delays used to coherently combine signals of the plurality of transmission nodes over a full operational bandwidth.

The method according to paragraphs above, wherein at least one of the one or more delays is computed to provide a best performance relative to other calculated delays according to a pre-defined metric.

The method according to paragraphs above, where the one or more delays is a single delay.

The method according to paragraphs above, wherein determining the channel state information further comprises: for each of the one or more delays, applying a corresponding delay for a selected one of the plurality of transmission nodes to a channel function for the selected transmission node to create a compensated channel function; and determining the channel state information using the compensated channel functions.

The method according to paragraphs above, wherein the estimating further comprises estimating the one or more delays using one or more of channel state information reference signals or cell-specific reference signals received in each of the transmissions.

The method according to paragraphs above, wherein the determining channel state information further comprises determining channel state information as one or more of a precoding matrix indicator, a channel quality indicator, and a rank indicator at least by compensating for the estimated one or more delays.

The method according to paragraphs above, further comprising quantizing the estimated one or more delays; and wherein the determining further comprises determining the channel state information using the quantized estimated one or more delays.

An apparatus comprising one or more processors; and one or more memories including computer program code, the one or more memories and the computer program code configured to, with the one or more processors, cause the apparatus to perform any one of the methods of the previous paragraphs. Specifically, the one or more memories and the computer program code configured to, with the one or more processors, cause the apparatus to perform: estimating one or more delays between transmissions received at the apparatus from a plurality of transmission nodes, determining channel state information by compensating for the estimated one or more delays, and sending indications of the channel state information and the estimated one or more delays to at least one of the plurality of transmission nodes.

A computer program product comprising a computer-readable medium bearing computer program code embodied therein for use with a computer, the computer program code comprising code for performing any of the methods of the previous paragraphs. Specifically, the computer program code comprising: code for estimating, with a user equipment, one or more delays between receipt of transmissions at the user equipment from a plurality of transmission nodes, code for determining channel state information by compensating for the estimated one or more delays, and code for sending indications of the channel state information and the estimated one or more delays to at least one of the plurality of transmission nodes.

An apparatus comprising means for performing any one of the methods of the previous paragraphs. Specifically, the apparatus could comprise means for estimating, with a user equipment, one or more delays between transmissions received at the apparatus from a plurality of transmission nodes, means for determining channel state information by compensating for the estimated one or more delays, and means for sending indications of the channel state information and the estimated one or more delays to at least one of the plurality of transmission nodes

The apparatus according to the paragraph above, wherein the means for estimating and determining comprises at least one memory including computer program code, the computer program code executable by at least one processor, and wherein the means for sending comprises an interface to a wireless network.

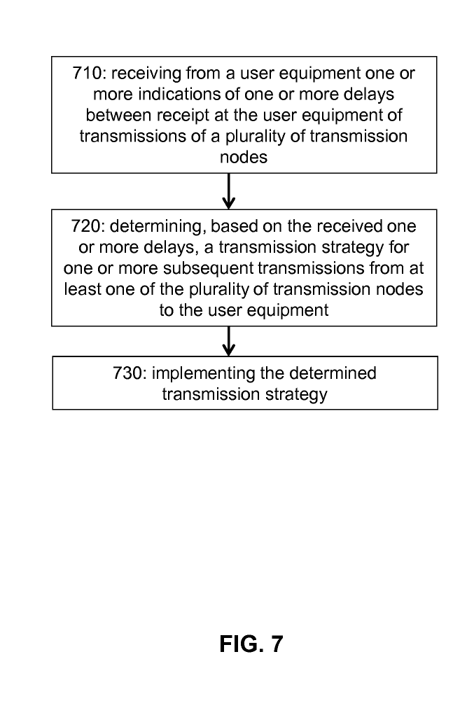

FIG. 7 is a block diagram illustrating another method in accordance with the exemplary embodiments of the invention. In accordance with exemplary embodiments of the invention, as illustrated at block 710 of FIG. 7 there is receiving from a user equipment one or more indications of one or more delays between receipt at the user equipment of transmissions of a plurality of transmission nodes. At block 720 there is determining, based on the received one or more delays, a transmission strategy for one or more subsequent transmissions from at least one of the plurality of transmission nodes to the user equipment, and at block 730 there is implementing the determined transmission strategy.

The method according to the paragraph above, wherein the determining further comprises determining that one or more subsequent transmissions are to be performed from a selected one of the plurality of transmission nodes, and wherein the implementing comprises causing the selected transmission node to transmit the one or more subsequent transmissions to the user equipment.

The method according to the paragraphs above, wherein the determining further comprises determining that one or more frequency selective phases are to be adapted by the one or more of the plurality of transmission nodes, and wherein the implementing further comprises causing selected ones of the one or more transmission nodes to modify signaling of at least one subsequent transmission based on the one or more frequency selective phases prior to transmission.

The method according to the paragraphs above, wherein the one or more transmission nodes comprises at least two transmission nodes; wherein the one or more delays is a plurality of delays; wherein the one or more frequency selective phases is a plurality of frequency selective phases; wherein each of the plurality of frequency selective phases is determined using a corresponding one of the plurality of delays; and wherein the method further comprises causing the at least two transmission nodes to transmit a subsequent transmission based on corresponding ones of the plurality of frequency selective phases.

The method according to the paragraphs above, wherein the one or more transmission nodes comprises at least two transmission nodes; wherein the one or more delays is a single delay; wherein the one or more frequency selective phases is single frequency selective phase, wherein the single frequency selective phase is determined using the single delay; and wherein the method further comprises causing signals to be transmitted further comprises causing the at least two transmission nodes to transmit a subsequent transmission based on the single frequency selective phase.

The method according to the paragraphs above, wherein the modifying the signal of the at least one corresponding transmission based on the one or more frequency selective phases comprises multiplying corresponding signals of the at least one subsequent transmission by exp(−j2π·f·τ), where f is a frequency and τ is a corresponding delay.

The method according to the paragraphs above, wherein the determining further comprises determining that cyclic shifts/delays should be adapted between the plurality of transmission nodes, wherein one or more cyclic shifts/delays are determined using the received one or more delays; and wherein the implementing further comprises causing signals of the one or more subsequent transmissions for selected ones of the plurality of transmission nodes to be cyclically shifted/delayed prior to transmission by a corresponding one of the one or more cyclic shifts/delays.

The method according to the paragraphs above, wherein the at least one transmission node comprises two or more transmission nodes, and wherein the one or more delays is a plurality of delays; and wherein the implementing comprises causing signals transmitted as part of the one or more subsequent transmissions for selected ones of the two or more transmission nodes to be cyclically shifted/delayed prior to transmission based on corresponding ones of the plurality of delays.

The method according to the paragraphs above, wherein the at least one transmission node comprises two or more transmission nodes; wherein the one or more delays is a single delay; wherein the implementing comprises causing signals to be transmitted as part of the one or more subsequent transmissions from selected ones of the two or more transmission nodes to be cyclically shifted/delayed prior to transmission based on the single delay.

The method according to the paragraphs above, wherein one of the plurality of transmission nodes is selected as a reference transmission node and wherein the one or more delays are relative to receipt at the user equipment of a transmission from the reference transmission node.

The method according to the paragraphs above, wherein each of the one or more delays is one of a plurality of predetermined quantized values.

An apparatus comprising one or more processors; and one or more memories including computer program code, the one or more memories and the computer program code configured to, with the one or more processors, cause the apparatus to perform any one of the methods of the previous paragraphs. Specifically, the one or more memories and the computer program code configured to, with the one or more processors, cause the apparatus to perform: receiving from a user equipment one or more indications of one or more delays between receipt at the user equipment of transmissions of a plurality of transmission nodes, determining, based on the received one or more delays, a transmission strategy for one or more subsequent transmissions from at least one of the plurality of transmission nodes to the user equipment, and implementing the determined transmission strategy.

A computer program product comprising a computer-readable medium bearing computer program code embodied therein for use with a computer, the computer program code comprising code for performing any of the methods of the previous paragraphs. Specifically, the computer program code comprising: code for receiving from a user equipment one or more indications of one or more delays between receipt at the user equipment of transmissions of a plurality of transmission nodes, code for determining, based on the received one or more delays, a transmission strategy for one or more subsequent transmissions from at least one of the plurality of transmission nodes to the user equipment, and code for implementing the determined transmission strategy.

An apparatus comprising means for performing any one of the methods of the previous paragraphs. Specifically, the apparatus could comprise means for receiving from a user equipment one or more indications of one or more delays between receipt at the user equipment of transmissions of a plurality of transmission nodes; means for determining, based on the received one or more delays, a transmission strategy for one or more subsequent transmissions from at least one of the plurality of transmission nodes to the user equipment, and means for implementing the determined transmission strategy.

The apparatus according to the paragraph above, wherein the means for determining and implementing comprises at least one memory including computer program code, the computer program code executable by at least one processor, and wherein the means for receiving comprises an interface to a wireless network.

Embodiments of the present invention may be implemented in software (executed by one or more processors), hardware, or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., device) that may be any media or means that can contain or store the instructions for use by or in connection with a system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out above.

It is also noted herein that while the above describes example embodiments of the invention, these descriptions should not be viewed in a limiting sense. Rather, there are several variations and modifications which may be made without departing from the scope of the present invention.

While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-48. (canceled)

49. A method comprising:
receiving from a user equipment one or more indications of one or more delays between receipt at the user equipment of transmissions of a plurality of transmission nodes;
determining, based on the received one or more delays, a transmission strategy for one or more subsequent transmissions from at least one of the plurality of transmission nodes to the user equipment, wherein the determining further comprises determining that one or more frequency selective phases are to be adapted by the one or more of the plurality of transmission nodes; and
implementing the determined transmission strategy, wherein the implementing further comprises causing selected ones of the one or more transmission nodes to modify signaling of at least one subsequent transmission based on the one or more frequency selective phases prior to transmission.

50. The method according to claim 49, wherein the determining further comprises determining that one or more subsequent transmissions are to be performed from a selected one of the plurality of transmission nodes, and wherein the implementing comprises causing the selected transmission node to transmit the one or more subsequent transmissions to the user equipment.

51. The method according to claim 49, wherein the one or more transmission nodes comprises at least two transmission nodes; wherein the one or more delays is a plurality of delays; wherein the one or more frequency selective phases is a plurality of frequency selective phases; wherein each of the plurality of frequency selective phases is determined using a corresponding one of the plurality of delays; and wherein the method further comprises causing the at least two transmission nodes to transmit a subsequent transmission based on corresponding ones of the plurality of frequency selective phases.

52. The method according to claim 49, wherein the one or more transmission nodes comprises at least two transmission nodes; wherein the one or more delays is a single delay; wherein the one or more frequency selective phases is single frequency selective phase, wherein the single frequency selective phase is determined using the single delay; and wherein the method further comprises causing signals to be transmitted further comprises causing the at least two transmission nodes to transmit a subsequent transmission based on the single frequency selective phase.

53. The method according to claim 49, wherein the modifying the signal of the at least one corresponding transmission based on the one or more frequency selective phases comprises multiplying corresponding signals of the at least one subsequent transmission by exp(−j2π·f·τ), where f is a frequency and τ is a corresponding delay.

54. The method according to claim 49, wherein the determining further comprises determining that cyclic shifts/delays should be adapted between the plurality of transmission nodes, wherein one or more cyclic shifts/delays are determined using the received one or more delays; and
wherein the implementing further comprises causing signals of the one or more subsequent transmissions for selected ones of the plurality of transmission nodes to be cyclically shifted/delayed prior to transmission by a corresponding one of the one or more cyclic shifts/delays.

55. The method according to claim 54, wherein the at least one transmission node comprises two or more transmission nodes, and wherein the one or more delays is a plurality of delays; and wherein the implementing comprises causing signals transmitted as part of the one or more subsequent transmissions for selected ones of the two or more transmission nodes to be cyclically shifted/delayed prior to transmission based on corresponding ones of the plurality of delays.

56. The method according to claim 54, wherein the at least one transmission node comprises two or more transmission nodes; wherein the one or more delays is a single delay; wherein the implementing comprises causing signals to be transmitted as part of the one or more subsequent transmissions from selected ones of the two or more transmission nodes to be cyclically shifted/delayed prior to transmission based on the single delay.

57. The method according to claim 49, wherein one of the plurality of transmission nodes is selected as a reference transmission node and wherein the one or more delays are relative to receipt at the user equipment of a transmission from the reference transmission node.

58. The method according to claim 49, wherein each of the one or more delays is one of a plurality of predetermined quantized values.

59. An apparatus comprising:
at least one processor; and
at least one memory including computer program code, where the at least one memory and the computer program code are configured, with the at least one processor, to cause the apparatus to at least:
receive from a user equipment one or more indications of one or more delays between receipt at the user equipment of transmissions of a plurality of transmission nodes;
determine, based on the received one or more delays, a transmission strategy for one or more subsequent transmissions from at least one of the plurality of transmission nodes to the user equipment;
determine that one or more frequency selective phases are to be adapted by the one or more of the plurality of transmission nodes; and implement the determined transmission strategy and cause selected ones of the one or more transmission nodes to modify signaling of at least one subsequent transmission based on the one or more frequency selective phases prior to transmission.

60. The apparatus according to claim 59, wherein the at least one memory including the computer program code is configured, with the at least one processor, to cause the apparatus to:
determine that one or more subsequent transmissions are to be performed from a selected one of the plurality of transmission nodes; and
cause the selected transmission node to transmit the one or more subsequent transmissions to the user equipment.

61. The apparatus according to claim 59, wherein the one or more transmission nodes comprises at least two transmission nodes; wherein the one or more delays is a plurality of delays; wherein the one or more frequency selective phases is a plurality of frequency selective phases; wherein each of the plurality of frequency selective phases is determined using a corresponding one of the plurality of delays; and wherein the at least one memory including the computer program code is configured, with the at least one processor, to cause the apparatus to cause the at least two transmission nodes to transmit a subsequent transmission based on corresponding ones of the plurality of frequency selective phases.

62. The apparatus according to claim 59, wherein the one or more transmission nodes comprises at least two transmission nodes; wherein the one or more delays is a single delay; wherein the one or more frequency selective phases is single frequency selective phase, wherein the single frequency selective phase is determined using the single delay; and wherein the at least one memory including the computer program code is configured, with the at least one processor, to cause the apparatus to the at least two transmission nodes to transmit a subsequent transmission based on the single frequency selective phase.

63. The apparatus according to claim 59, wherein the modifying the signal of the at least one corresponding transmission based on the one or more frequency selective phases comprises multiplying corresponding signals of the at least one subsequent transmission by exp(−j2π·f·τ), where f is a frequency and τ is a corresponding delay.

64. The apparatus according to claim 59, wherein the determining further comprises determining that cyclic shifts/delays should be adapted between the plurality of transmission nodes, wherein one or more cyclic shifts/delays are determined using the received one or more delays; and wherein the implementing further comprises causing signals of the one or more subsequent transmissions for selected ones of the plurality of transmission nodes to be cyclically shifted/delayed prior to transmission by a corresponding one of the one or more cyclic shifts/delays.

65. The apparatus according to claim 64, wherein the at least one transmission node comprises two or more transmission nodes, and wherein the one or more delays is a plurality of delays; and wherein the implementing comprises the at least one memory including the computer program code is configured, with the at least one processor, to cause the apparatus to cause signals transmitted as part of the one or more subsequent transmissions for selected ones of the two or more transmission nodes to be cyclically shifted/delayed prior to transmission based on corresponding ones of the plurality of delays.

66. The apparatus according to claim 64, wherein the at least one transmission node comprises two or more transmission nodes; wherein the one or more delays is a single delay; wherein the implementing comprises causing signals to be transmitted as part of the one or more subsequent transmissions from selected ones of the two or more transmission nodes to be cyclically shifted/delayed prior to transmission based on the single delay.

67. The apparatus according to claim 59, wherein one of the plurality of transmission nodes is selected as a reference transmission node and wherein the one or more delays are relative to receipt at the user equipment of a transmission from the reference transmission node.

68. The apparatus according to claim 59, wherein each of the one or more delays is one of a plurality of predetermined quantized values.
